(19) United States
(12) Patent Application Publication
(10) Pub. No.: US 2025/0021385 A1
(43) Pub. Date: Jan. 16, 2025

(54) COMPUTER SYSTEM, INFRASTRUCTURE MANAGEMENT METHOD, AND NON-TRANSITORY COMPUTER READABLE MEDIUM

(71) Applicant: Hitachi, Ltd., Tokyo (JP)

(72) Inventors: Iku MATSUI, Tokyo (JP); Hirofumi FUJITA, Tokyo (JP); Hajime YAMADA, Tokyo (JP)

(21) Appl. No.: 18/591,139

(22) Filed: Feb. 29, 2024

(30) Foreign Application Priority Data
Jul. 11, 2023 (JP) 2023-113920

(51) Int. Cl. G06F 9/50

(52) U.S. Cl. CPC G06F 9/5016

(57) ABSTRACT

A storage pool for allocating a storage area to a volume to be used by an instance constituting a service is selected. At least two infrastructures provide an environment for constructing a business system including instances, at least one infrastructure includes a plurality of storage pools for allocating a storage area to a volume to be used by an instance, and a management system holds management information for centrally managing a plurality of business systems. A computer provided in an infrastructure managing a storage pool makes an inquiry about an attribute of an instance to the management system when an allocation request to allocate a storage area to a volume to be used by the instance is received, receives information on the attribute of the instance, retrieves an available storage pool based on the received information, and generates display information for presenting the retrieved storage pool.

### CLAIM OF PRIORITY

The present application claims priority from Japanese patent application JP 2023-113920 filed on Jul. 11, 2023, the content of which is hereby incorporated by reference into this application.

### BACKGROUND OF THE INVENTION

### 1. Field of the Invention

The present invention relates to an infrastructure management technique of a hybrid cloud.

### 2. Description of Related Art

In recent years, the use of hybrid clouds has spread. In order to automatically construct a business system, an infrastructure as code (IaC) tool is used. By using the IaC tool, the business system can be efficiently constructed.

### CITATION LIST

### Patent Literature

Patent Literature 1: JP2021-530803A

### SUMMARY OF THE INVENTION

Even when the IaC tool is used, manual design is necessary in terms of security, compliance, and the like required for instances constituting the business system. In particular, volumes used by the instances have many restrictions on security and compliance. Therefore, in the related art, an administrator of the infrastructure needs to gather opinions from a developer or an operator of the business system and determine a storage pool for allocating a storage area to a volume.

A technique disclosed in Patent Literature 1 is known as a technique of volume provisioning.

The invention provides a technique for supporting selection of a storage pool for allocating a storage area to a volume used by an instance.

A representative example of the invention disclosed in the present application is as follows. That is, there is provided a computer system including a plurality of infrastructures and a management system. The plurality of infrastructures include a plurality of computers each including a processor, a storage device connected to the processor, and a network interface connected to the processor. At least two of the infrastructures provide an environment for constructing a business system including at least one instance, at least one of the infrastructures includes a plurality of storage pools for allocating a storage area to a volume to be used by the instance, and the management system holds management information for centrally managing a plurality of the business systems constructed on the infrastructure that provides the environment. A management computer that is the computer provided in the infrastructure managing the plurality of storage pools makes an inquiry about an attribute representing a characteristic of a target instance to the management system when an allocation request to allocate a storage area to a volume to be used by the target instance is received, receives, from the management system, information on the attribute of the target instance for the inquiry which is generated using the management information, retrieves an available storage pool from among the plurality of storage pools based on the received information, and generates and outputs display information for presenting the retrieved storage pool.

According to the invention, it is possible to support selection of a storage pool for allocating a storage area to a volume used by an instance. Problems, configurations, and effects other than those described above will be clarified by description of the following embodiments.

### BRIEF DESCRIPTION OF THE DRAWINGS

FIG. 1 is a diagram illustrating a configuration example of a computer system according to a first embodiment;

FIG. 2 is a diagram illustrating a configuration example of an infrastructure according to the first embodiment;

FIG. 3 is a diagram illustrating an example of a hardware configuration of a computer constituting the infrastructure according to the first embodiment;

FIG. 4 is a diagram illustrating an example of a functional configuration of a management server according to the first embodiment;

FIG. 5 is a diagram illustrating an example of a data structure of storage pool management information according to the first embodiment;

FIG. 6 is a diagram illustrating an example of a data structure of policy management information according to the first embodiment;

FIG. 7 is a diagram illustrating an example of a data structure of instance management information held by a management system according to the first embodiment;

FIG. 8 is a diagram illustrating an example of a data structure of connection management information held by the management system according to the first embodiment;

FIG. 9 is a flowchart illustrating an outline of processing executed by the management server according to the first embodiment;

FIG. 10 is a diagram illustrating an example of a data structure of storage pool management information according to the first embodiment;

FIG. 11A is a flowchart illustrating an example of instance attribute specifying processing executed by the management server according to the first embodiment;

FIG. 11B is a flowchart illustrating an example of the instance attribute specifying processing executed by the management server according to the first embodiment;

FIG. 12 is a diagram illustrating an example of instance attribute information generated by the management server according to the first embodiment; and

FIG. 13 is a flowchart illustrating an example of storage pool retrieval processing executed by the management server according to the first embodiment.

### DESCRIPTION OF EMBODIMENTS

Hereinafter, embodiments of the invention will be described with reference to the drawings. However, the invention is not to be construed as being limited to the description of the following embodiments. It will be easily understood by those skilled in the art that the specific configuration can be changed without departing from the spirit or scope of the invention.

In the configurations of the invention described below, the same or similar configurations or functions are denoted by the same reference signs, and a redundant description thereof will be omitted.

Notations “first”, “second”, “third”, and the like in the present specification and the like are provided to identify components, and do not necessarily limit the number or the order of those components.

### First Embodiment

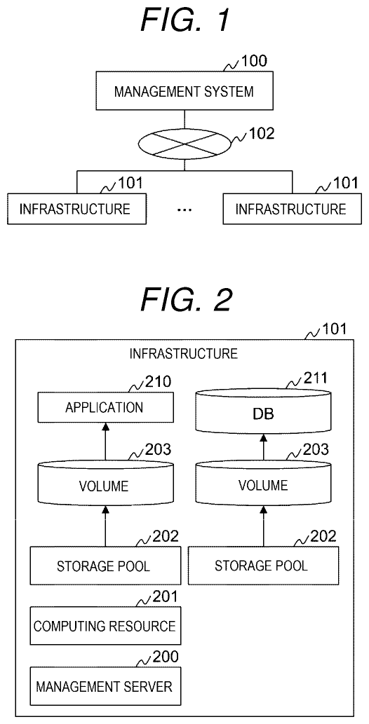

FIG. 1 is a diagram illustrating a configuration example of a computer system according to a first embodiment.

The computer system includes a management system 100 and a plurality of infrastructures 101. The management system 100 and the plurality of infrastructures 101 are connected to each other via a network 102 such as a wide area network (WAN) and a local area network (LAN).

The infrastructure 101 provides an environment for constructing a business system. The infrastructure 101 is, for example, an on-premises system, a private cloud system, or a public cloud system.

The management system 100 centrally manages a plurality of business systems constituting one business flow. The management system 100 is, for example, an integration platform as a service (iPaaS) and a cloud management platform (CMP).

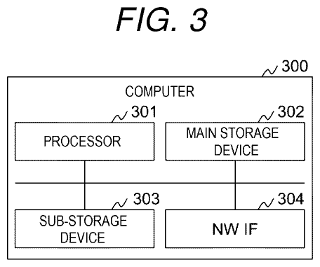

FIG. 2 is a diagram illustrating a configuration example of the infrastructure according to the first embodiment. FIG. 3 is a diagram illustrating an example of a hardware configuration of a computer constituting the infrastructure according to the first embodiment.

The infrastructure 101 provides an environment for constructing a business system including instances such as an application 210 and a DB 211. The infrastructure 101 includes a management server 200 and a computing resource 201 that includes a computer 300 and the like. The computer 300 includes a processor 301, a main storage device 302, a sub-storage device 303, and a network interface 304. The computing resource 201 may include a network switch and a storage device.

On the infrastructure 101, one or more business systems including instances implemented by using e computing resource 201 are constructed. The infrastructure 101 includes a storage pool 202. The infrastructure 101 allocates a storage area of the storage pool 202 to a volume used by the application 210 or the DB 211.

The computer system may include the infrastructure 101 that does not include the storage pool 202. The computer system may include the infrastructure 101 that does not include an instance but includes only the storage pool 202.

The management server 200 manages the computing resource 201 and the storage pool 202. The management server 200 may be implemented using a physical computer or a virtual computer. The management server 200 according to the embodiment presents a candidate of the storage pool 202 for allocating a storage area to a volume 203.

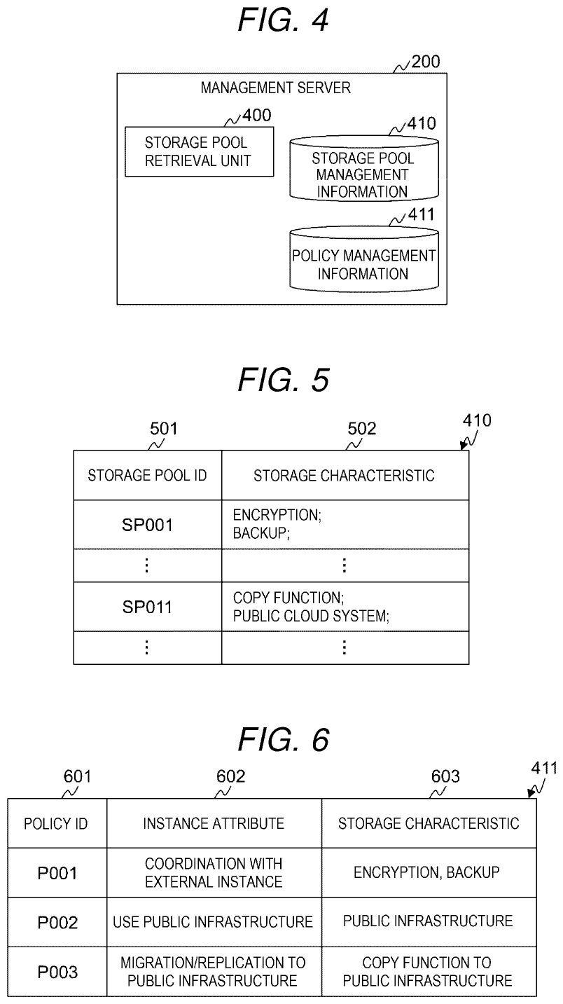

FIG. 4 is a diagram illustrating an example of a functional configuration of the management server 200 according to the first embodiment.

The management server 200 includes a storage pool retrieval unit 400, and holds storage pool management information 410 and policy management information 411.

FIG. 5 is a diagram illustrating an example of a data structure of the storage pool management information 410 according to the first embodiment.

The storage pool management information 410 is information for managing the storage pool 202. The storage pool management information 410 stores an entry including a storage pool ID 501 and a storage characteristic 502. One entry exists for one storage pool 202. The fields included in the entry are not limited to those described above. Any of the above-described fields may not be included, and other fields may be included. For example, a field for storing a list of storage devices constituting a storage pool may be included.

The storage pool ID 501 is a field for storing an ID of the storage pool 202. The storage characteristic 502 is a field for storing information on a characteristic of the storage pool 202. The storage characteristic 502 stores, for example, functions of the storage pool 202, and the type and region of the infrastructure 101 that manages the storage pool 202.

FIG. 6 is a diagram illustrating an example of a data structure of the policy management information 411 according to the first embodiment.

The policy management information 411 is information for managing a policy for selecting the storage pool 202 for allocating a storage area to a volume used by an instance. The policy management information 411 stores an entry including a policy ID 601, an instance attribute 602, and a storage characteristic 603. One entry exists for one policy. The fields included in the entry are not limited to those described above. Any of the above-described fields may not be included, and other fields may be included.

The policy ID 601 is a field for storing an ID of the policy. The instance attribute 602 is a field for storing an attribute of an instance. The storage characteristic 603 is a field for storing a characteristic required for the storage pool 202.

The policy manages the correspondence of the characteristic of the required storage pool 202 to the attribute of the instance.

The management system 100 holds, for example, instance management information 700 for managing instances and connection management information 800 for managing coordination of instances.

The policy management information 411 may be set for each business flow or for each user.

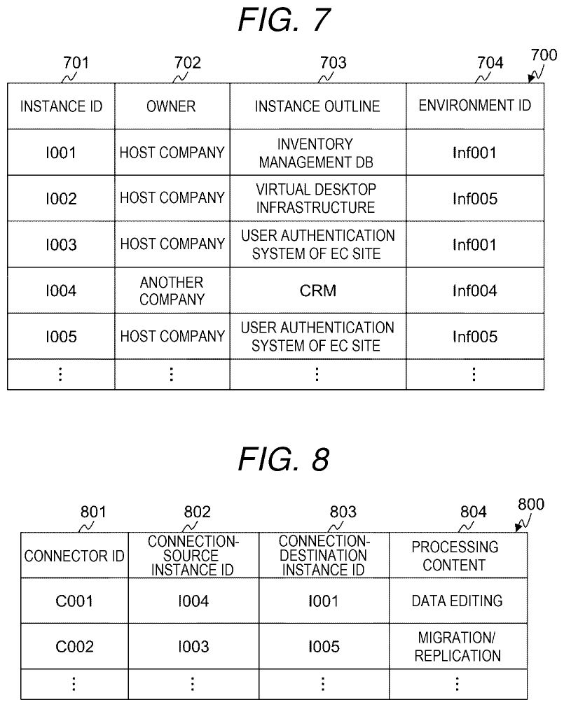

FIG. 7 is a diagram illustrating an example of a data structure of the instance management information 700 held by the management system 100 according to the first embodiment.

The management system 100 holds the instance management information 700 for each business flow. The instance management information 700 stores an entry including an instance ID 701, an owner 702, an instance outline 703, and an environment ID 704. One entry exists for one instance. The fields included in the entry are not limited to those described above. Any of the above-described fields may not be included, and other fields may be included.

The instance ID 701 is a field for storing an ID of an instance. The owner 702 is a field for storing information indicating an owner of the instance. The instance outline 703 is a field for storing information indicating the type, function, and the like of the instance. The environment ID 704 is a field for storing an ID of the environment (infrastructure 101) in which the instance operates.

The instance management information 700 may be set for each business flow or for each user.

FIG. 8 is a diagram illustrating an example of a data structure of the connection management information 800 held by the management system 100 according to the first embodiment.

The management system 100 holds the connection management information 800 for each business flow. The connection management information 800 stores an entry including a connector ID 801, a connection-source instance ID 802, a connection-destination instance ID 803, and processing content 804. One entry exists for a combination of coordinated instances. The fields included in the entry are not limited to those described above. Any of the above-described fields may not be included, and other fields may be included.

The connector ID 801 is a field for storing an ID of a connector that connects coordinated instances. The connector is an edge having a direction. The connection-source instance ID 802 is a field for storing an ID of a connection-source instance of the connector. The connection-destination instance ID 803 is a field for storing an ID of a connection-destination instance of the connector. The processing content 804 is a field for storing information indicating processing related to coordination of instances.

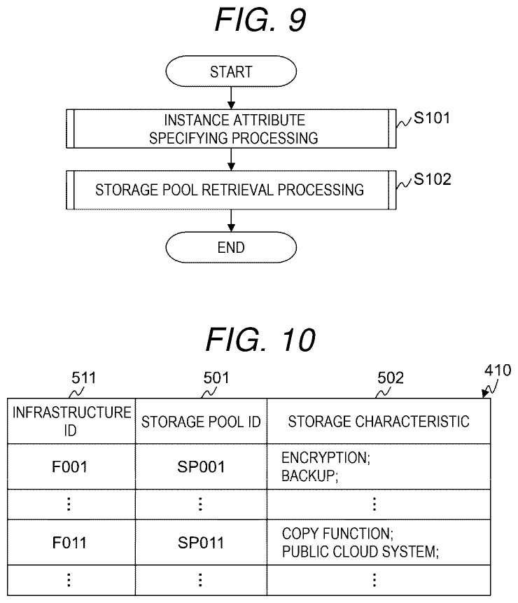

FIG. 9 is a flowchart illustrating an outline of processing executed by the management server 200 according to the first embodiment.

When the management server 200 provided in the infrastructure 101 having the storage pool 202 receives a volume allocation request from a developer or an operator of the business system, the management server 200 executes processing described below. The volume allocation request includes business flow identification information and an instance (target instance) ID.

First, the management server 200 executes instance attribute specifying processing (step S101). In the instance attribute specifying processing, the attribute of the target instance is identified. Details of the processing will be described later.

Next, the management server 200 executes storage pool retrieval processing (step S102). In the storage pool retrieval processing, candidates for the storage pool 202 are retrieved. Details of the processing will be described later.

In the first embodiment, the management server 200 retrieves the available storage pool 202 from the storage pools 202 provided in the infrastructure 101 that includes the management server 200.

The processing illustrated in FIG. 9 may be executed by the management server 200 provided in the infrastructure 101 that does not include the storage pool 202. In this case, the management server 200 provided in the infrastructure 101 not including the storage pool 202 can execute the same processing by communicating with the management server 200 provided in the infrastructure 101 including the storage pool 202. The processing may be executed using the storage pool management information 410 (see FIG. 10) described later.

The processing shown in FIG. 9 may be executed by the management server 200 provided in the infrastructure 101 that centrally manages the storage pools 202 in the computer system. In this case, the management server 200 holds the storage pool management information 410 as shown in FIG. 10. An entry of the storage pool management information 410 shown in FIG. 10 includes an infrastructure ID 511. The infrastructure ID 511 is a field for storing the ID of the infrastructure 101 that provides the storage pool 202. The management server 200 retrieves the available storage pool 202 from the storage pools 202 in the computer system.

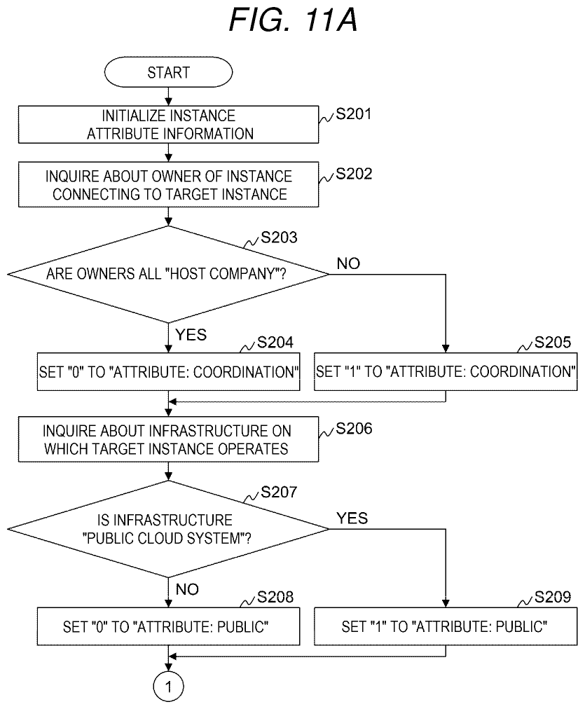

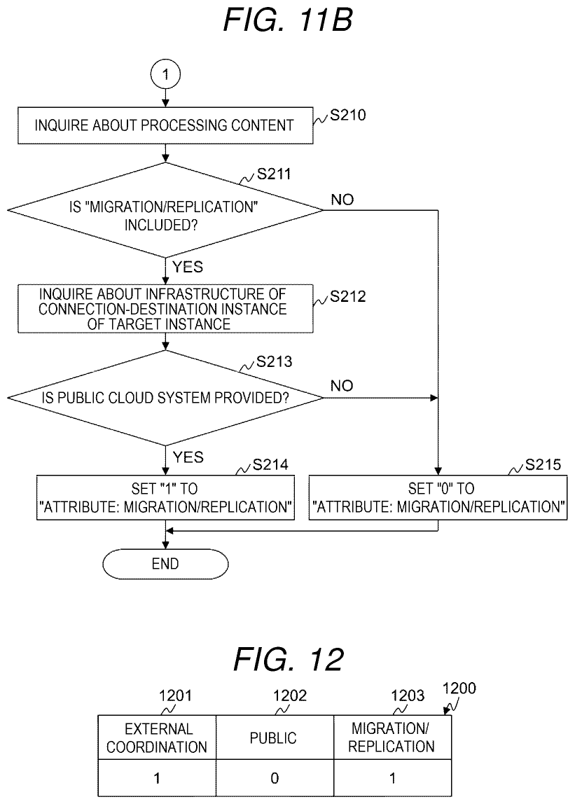

FIGS. 11A and 11B are flowcharts illustrating an example of the instance attribute specifying processing executed by the management server 200 according to the first embodiment. FIG. 12 is a diagram illustrating an example of instance attribute information generated by the management server 200 according to the first embodiment.

The management server 200 initializes instance attribute information 1200 (step S201).

Here, the instance attribute information 1200 will be described. The instance attribute information 1200 includes external coordination 1201, public 1202, and migration/replication 1203. The fields are not limited to those described above. Any of the above-described fields may not be included, and other fields may be included.

The external coordination 1201 is a field for storing a flag indicating whether to coordinate with an instance whose owner is not a host company (for example, a developer who requests allocation of a volume). When coordinating with an instance whose owner is not the host company, “1” is set, and when not coordinating with an instance whose owner is not the host company, “0” is set.

The public 1202 is a field for storing a flag indicating whether the environment in which the instance operates is a public cloud system. When the environment in which the instance operates is a public cloud system, “1” is set, and when the environment in which the instance operates is not a public cloud system, “0” is set.

The migration/replication 1203 is a field for storing a flag indicating whether the processing content related to the coordination of instances is migration or replication of the instances to a public cloud system. When the processing content related to the coordination of the instances is migration or replication of the instances to the public cloud system, “1” is set, and when the processing content related to the coordination of the instances is not migration or replication of the instances to the public cloud system, “0” is set.

In step S201, the management server 200 generates the instance attribute information 1200 in which the external coordination 1201, the public 1202, and the migration/replication 1203 are blank.

The management server 200 makes an inquiry about the owner of the connection-source instance of the target instance to the management system 100 (step S202). The inquiry includes the business flow identification information and the ID of the target instance.

When the inquiry is received, the management system 100 refers to the connection management information 800 corresponding to the business flow and retrieves an entry in which the ID of the target instance is stored in the connection-destination instance ID 803. The management system 100 acquires the ID of the: instance from the connection-source instance ID 802 of the retrieved entry. The management system 100 refers to the instance management information 700 corresponding to the business flow and retrieves an entry in which the acquired ID of the instance is stored in the instance ID 701. The management system 100 returns a value stored in the owner 702 of the retrieved entry to the management server 200.

When there are a plurality of connection-source instances, the management system 100 notifies the owner of each instance.

Based on the response to the inquiry, the management server 200 determines whether owners of the connection-source instances of the target instance are all “host company” (step S203).

When the owners of the connection-source instances of the target instance are all “host company”, the management server 200 sets “0” in the external coordination 1201 of the instance attribute information 1200 (step S204), and then proceeds to step S206.

When the owner of at least one connection-source instance of the target instance is “another company”, the management server 200 sets “1” in the external coordination 1201 of the instance attribute information 1200 (step S205), and then proceeds to step S206.

In step S206, the management server 200 makes an inquiry about the infrastructure 101, on which the target instance operates, to the management system 100 (step S206). The inquiry includes the business flow identification information and the ID of the target instance.

When the inquiry is received, the management system 100 refers to the instance management information 700 corresponding to the business flow and retrieves an entry in which the ID of the target instance is stored in the instance ID 701. The management system 100 returns a value stored in the environment ID 704 of the retrieved entry to the management server 200.

Based on the response to the inquiry, the management server 200 determines whether the infrastructure 101 on which the target instance operates is a public cloud system (step S207).

When the infrastructure 101 on which the target instance operates is not a public cloud system, the management server 200 sets “0” in the public 1202 of the instance attribute information 1200 (step S208), and then proceeds to step S210.

When the infrastructure 101 on which the target instance operates is a public cloud system, the management server 200 sets “1” in the public 1202 of the instance attribute information 1200 (step S209), and then proceeds to step S210.

In step S210, the management server 200 makes an inquiry about the processing content of the coordination, in which the target instance is the connection source, to the management system 100 (step S210). The inquiry includes the business flow identification information and the ID of the target instance.

When the inquiry is received, the management system 100 refers to the connection management information 800 corresponding to the business flow and retrieves an entry in which the ID of the target instance is stored in the connection-source instance ID 802. The management system 100 returns a value stored in the processing content 804 of the retrieved entry to the management server 200.

When there are a plurality of connection-destination instances, that is, when there are a plurality of connectors, the management system 100 notifies each connector of the processing content.

Based on the response to the inquiry, the management server 200 determines whether the migration/replication is included in the processing content of the coordination in which the target instance is the connection source (step S211).

When the migration/replication is not included in the processing content of the coordination in which the target instance is the connection source, the management server 200 sets “0” in the migration/replication 1203 of the instance attribute information 1200 (step S215), and then ends the processing.

When the migration/replication is included in the processing content of the coordination in which the target instance is the connection source, the management server 200 inquires about the infrastructure 101 on which the connection-destination instance of the target instance to be migrated/replicated operates (step S212). The inquiry includes the business flow identification information and the ID of the connection-destination instance.

When the inquiry is received, the management system 100 refers to the instance management information 700 corresponding to the business flow and retrieves an entry in which the ID of the connection-destination instance is stored in the instance ID 701. The management system 100 returns a value stored in the environment ID 704 of the retrieved entry to the management server 200.

Based on the response to the inquiry, the management server 200 determines whether a public cloud system is provided in the infrastructure 101 on which the connection-destination instance of the target instance to be migrated/replicate operates (step S213).

When a public cloud system is provided in the infrastructure 101 on which the connection-destination instance of the target instance to be migrated/replicated operates, the management server 200 sets “1” in the migration/replication 1203 of the instance attribute information 1200 (step S214), and then ends the processing.

When no public cloud system is provided in the infrastructure 101 on which the connection-destination instance of the target instance to be migrated/replicated operates, the management server 200 sets “0” in the migration/replication 1203 of the instance attribute information 1200 (step S215), and then ends the processing.

The management system 100 such as the integration platform as a service (iPaaS) and CMP is used by a user who develops or operates a business system, and has not been used for management of the infrastructure 101 in the related art. The embodiment is characterized in that information held by the management system 100 is used to support “selection of the storage pool 202”, which is one item of the management of the infrastructure 101.

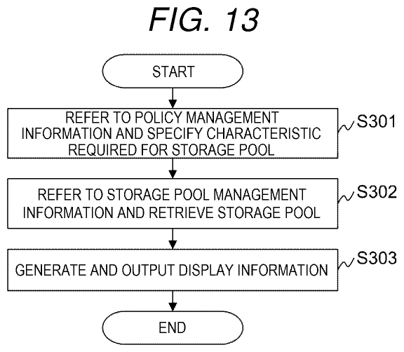

FIG. 13 is a flowchart illustrating an example of the storage pool retrieval processing executed by the management server 200 according to the first embodiment.

The management server 200 refers to the policy management information 411 based on the instance attribute information 1200, and specifies a characteristic (storage characteristic) required for the storage pool 202 (step S301).

Specifically, the management server 200 retrieves an entry in which an attribute corresponding to a field in which “1” is set is stored in the instance attribute 602. The management server 200 acquires a value stored in the storage characteristic 603 of the retrieved entry.

For example, when “1” is set in the external coordination 1201, the entry with the policy ID 601 of “P001” is retrieved. In this case, “encryption” and “backup” are storage characteristics.

The management server 200 refers to the storage pool management information 410 and retrieves the storage pool 202 having the specified storage characteristics (step S302).

Specifically, the management server 200 retrieves an entry in which a value corresponding to the specified storage characteristics is stored in the storage characteristic 502.

The management server 200 generates display information for displaying a retrieval result, and outputs the display information to an administrator of the infrastructure 101 including the storage pool 202 (step S303).

For example, when the storage pool 202 having the specified storage characteristics is present, the management server 200 generates display information for displaying the storage pool 202. In step S302, when the storage pool 202 having the specified storage characteristics is not present, the management server 200 generates display information for displaying the absence of the storage pool 202 and the storage characteristics. The administrator of the infrastructure 101 can set a new storage pool 202 in the infrastructure 101 to by referring the storage characteristics.

As described above, in the embodiment, it is possible to support the selection of a storage pool to allocate a storage area to a volume to be used by an instance, by using information held by the management system 100 that performs central management of a business service.

The invention is not limited to the above-described embodiments, and includes various modifications. For example, the above-described embodiments are described in detail in order to describe the invention in an easy-to-understand manner, and the invention is not necessarily limited to those including all the described configurations. A part of a configuration in each embodiment may be added to, deleted from, or replaced with another configuration.

Some or all of the configurations, functions, processing units, processing methods, and the like described above may be implemented by hardware by, for example, designing with an integrated circuit. The invention can also be implemented by a program code of software for implementing the functions in the embodiments. In this case, a storage medium storing the program code is provided to a computer, and a processor provided in the computer reads the program code stored in the storage medium. In this case, the program code read from the storage medium implements the functions of the embodiments described above by itself, and the program code itself and the storage medium storing the program code constitute the invention. Examples of the storage medium for supplying such a program code include a flexible disk, a CD-ROM, a DVD-ROM, a hard disk, a solid state drive (SSD), an optical disk, a magneto-optical disk, a CD-R, a magnetic tape, a nonvolatile memory card, and a ROM.

Further, the program code for implementing the functions described in the embodiments can be implemented in a wide range of programs or script languages such as assembler, C/C++, Perl, Shell, PHP, Python, and Java (registered trademark).

Further, the program code of the software for implementing the functions in the embodiments may be distributed via a network to be stored in a storage unit such as a hard disk or a memory of a computer or a storage medium such as a CD-RW or a CD-R, and a processor provided in the computer may read and execute the program code stored in the storage unit or the storage medium.

Control lines and information lines considered to be necessary for description are illustrated in the embodiments described above, and not all control lines and information lines in a product are necessarily illustrated. All the configurations may be connected to one another.

What is claimed is:

1. A computer system comprising a plurality of infrastructures and a management system, wherein
the plurality of infrastructures include a plurality of computers each including a processor, a storage device connected to the processor, and a network interface connected to the processor,
at least two of the infrastructures provide an environment for constructing a business system including at least one instance,
at least one of the infrastructures includes a plurality of storage pools for allocating a storage area to a volume to be used by the instance,
the management system holds management information for centrally managing a plurality of the business systems constructed on the infrastructure that provides the environment, and
a management computer that is the computer provided in the infrastructure managing the plurality of storage pools
makes an inquiry about an attribute representing a characteristic of a target instance to the management system when an allocation request to allocate a storage area to a volume to be used by the target instance is received,
receives, from the management system, information on the attribute of the target instance for the inquiry which is generated using the management information,
retrieves an available storage pool from among the plurality of storage pools based on the received information, and
generates and outputs display information for presenting the retrieved storage pool.

2. The computer system according to claim 1, wherein
the infrastructure including the plurality of storage pools holds policy management information for managing correspondence between an attribute of the instance and a characteristic of a required storage pool and storage pool management information for managing a configuration of the plurality of storage pools, and
the management computer
refers to the policy management information to specify a characteristic of the storage pool corresponding to the attribute of the target instance, and
refers to the storage pool management information the storage having the specified to retrieve pool characteristic of the storage pool.

3. The computer system according to claim 2, wherein
when no available storage pool is present, the management computer generates the display information including the attribute of the target instance.

4. The computer system according to claim 2, wherein
the allocation request is transmitted from a user who develops or operates the business system, and
the display information is output to an administrator of the infrastructure including the storage pool.

5. The computer system according to claim 2, wherein
the plurality of infrastructures include at least one of an on-premises system, a private cloud system, and a public cloud system.

6. The computer system according to claim 2, wherein
the management system is a system that provides iPaaS.

7. An infrastructure management method for a computer system including a plurality of infrastructures and a management system,
the plurality of infrastructures including a plurality of computers each including a processor, a storage device connected to the processor, and a network interface connected to the processor,
at least two of the infrastructures providing an environment for constructing a business system including at least one instance,
at least one of the infrastructures including a plurality of storage pools for allocating a storage area to a volume to be used by the instance,
the management system holding management information for centrally managing a plurality of the business systems constructed on the infrastructure that provides the environment,
the infrastructure management method comprising:
a first step of a management computer, which is the computer provided in the infrastructure managing the plurality of storage pools, making an inquiry about an attribute representing a characteristic of a target instance to the management system when an allocation request to allocate a storage area to a volume to be used by the target instance is received,
a second step of the management computer receiving information on the attribute of the target instance for the inquiry which is generated using the management information,
a third step of the management computer retrieving an available storage pool from among the plurality of storage pools based on the received information, and
a fourth step of the management computer generating and outputting display information for presenting the retrieved storage pool.

8. The infrastructure management method according to claim 7, wherein
the infrastructure, which includes the plurality of storage pools, holds policy management information for managing correspondence between an attribute of the instance and a characteristic of a required storage pool and storage pool management information for managing a configuration of the plurality of storage pools, and
the third step includes
a step of the management computer referring to policy to specify the management information a characteristic of the storage pool corresponding to the attribute of the target instance, and
a step of the management computer referring to the storage pool management information to retrieve the storage pool having the specified characteristic of the storage pool.

9. The infrastructure management method according to claim 8, wherein
the fourth step includes a step of the management computer generating the display information including the attribute of the target instance when no available storage pool is present.

10. The infrastructure management method according to claim 8, wherein
the allocation request is transmitted from a user who develops or operates the business system, and
the display information is output to an administrator of the infrastructure including the storage pool.

11. The infrastructure management method according to claim 8, wherein
the plurality of infrastructures include at least one of an on-premises system, a private cloud system, and a public cloud system.

12. The infrastructure management method according to claim 8, wherein
the management system is a system that provides iPaaS.

13. A non-transitory computer readable medium storing a program to be executed by a computer provided in an infrastructure managing a plurality of storage pools for allocating a storage area to a volume to be used by an instance constituting a business system,
the computer connecting to a plurality of infrastructures providing an environment for constructing the business system and to a management system holding management information for centrally managing a plurality of the business systems constructed on the plurality of infrastructures,
the program causing the computer to execute
a first procedure of making an inquiry about an attribute representing a characteristic of a target instance to the management system when an allocation request to allocate a storage area to a volume to be used by the target instance is received,
a second procedure of receiving information on the attribute of the target instance for the inquiry which is generated using the management information,
a third procedure of retrieving an available storage pool from among the plurality of storage pools based on the received information, and
a fourth procedure of generating and outputting display information for presenting the retrieved storage pool.

14. The non-transitory computer readable medium according to claim 13, wherein
the computer holds policy management information for managing correspondence between an attribute of the instance and a characteristic of a required storage pool and storage pool management information for managing a configuration of the plurality of storage pools, and
the third procedure includes
a step of referring to the policy management information to specify a characteristic of the storage pool corresponding to the attribute of the target instance, and
a step of referring to the storage pool management information to retrieve the storage pool having the specified characteristic of the storage pool.

15. The non-transitory computer readable medium according to claim 14, wherein
the fourth procedure includes a procedure of generating the display information including the attribute of the target instance when no available storage pool is present.
